(19) United States
(12) Patent Application Publication
(10) Pub. No.: US 2007/0158332 A1
(43) Pub. Date: Jul. 12, 2007

(54) FAST-BROWNING PIZZA OVEN

(76) Inventor: Robert B. Stewart, Fremont, CA (US)

Correspondence Address: THE LUTHER LAW FIRM, 12198 E. COLUMBINE DR., SCOTTSDALE, AZ, 85259, US

(21) Appl. No.: 11/557,468

(22) Filed: Nov. 7, 2006

Related U.S. Application Data
(60) Provisional application No. 60/734,721, filed on Nov. 7, 2005.

(51) Int. Cl. H05B 3/68

(52) U.S. Cl. 219/443.1

(57) ABSTRACT

A fast-cooking table top oven has a. a housing with four sides, a base and a top, one side being the front of the oven, a portion of the front being capable of opening as a door, and another side being the back of the oven; b. a first heating element capable of keeping the housing at over 700° F., the first heating element being situated in the base of the housing; c. a deck that sits on the base of the housing and above the first heating element, the deck being suitable for cooking a food; d. a thermostat for monitoring the temperature of the inside of the housing; e. a second heating element situated in the top of the housing, suitable for browning a top surface of the food; f. a button situated on the front side of the housing next to the door; and g. a controller connected to the thermostat, the first heating element, the second heating element, the thermostat, and a button situated on the front side of the housing, whereby the controller maintains the temperature within the housing using the thermostat by directing power to the first heating element, until the button is actuated, t which time it transfers power to the second heating element such that the second heating element rapidly heats up and thereby promptly cooks a food. Also disclosed is a quick-browning method to be performed at over 600° F.

### RELATED APPLICATIONS

This application claims the benefit of U.S. Provisional Application No. 60/734,721, filed Nov. 7, 2005.

### TECHNICAL FIELD

The present invention relates to a cooking oven, specifically a cooking oven with dual heating elements, one to maintain a desired temperature and another to brown the top of the food.

### BACKGROUND

Pizza has been baked in a variety of ovens such as a gas canister oven, an eclectic deck oven, a conveyor belt over, and a wood or coal fired brick oven. Wood or coal fired ovens are considered far superior to conventional gas or electric ovens. The pizza is cooked evenly since heat is conducted from the floor below and at the same time radiated from the dome above. This provides the desirable characteristics of crisp crust and melted, even browned cheese. However, such ovens are bulky and more costly to build and maintain.

There have been many efforts to provide the public with a hot pizza which has both a crisp crust and melted cheese on top, without the cost of a restaurant meal. For example, there are pizza products designed to be cooked in a toaster or a toaster oven. While the toaster cooking is relatively fast and provides heat from two directions, the toaster oven is slow to heat up and only provides heat from one direction. For speedy heating, consumers often turn to their microwaves, for which a number of different packaging and product formulations have been developed. However, the results are recognized as clearly inferior to pizzas available in restaurants using brick ovens.

There is a need for a small oven capable of quickly browning pizza and providing a crisp crust. Preferably, an improved fast-browning pizza oven would imitate the effect of a brick oven with the added benefits of being smaller, quicker and cheaper to maintain.

### SUMMARY OF INVENTION

It is an object of this invention to provide a quick-browning oven that operates off standard current.

In one embodiment, there is provided a fast-cooking table top oven that has a. a housing with four sides, a base and a top, one side being the front of the oven, a portion of the front being capable of opening as a door, and another side being the back of the oven; b. a first heating element capable of keeping the housing at over 700° Fahrenheit, the first heating element being situated in the base of the housing; c. a deck that sits on the base of the housing and above the first heating element, the deck being suitable for cooking a food; d. a thermostat for monitoring the temperature of the inside of the housing; e. a second heating element situated in the top of the housing, suitable for browning a top surface of the food; f. a button situated on the front side of the housing next to the door; g. a controller connected to the thermostat, the first heating element, the second heating element, the thermostat, and a button situated on the front side of the housing, whereby the controller maintains the temperature within the housing using the thermostat by directing power to the first heating element, until the button is actuated, t which time it transfers power to the second heating element such that the second heating element rapidly heats up and thereby promptly cooks a food.

Optionally, the oven has insulation surrounding the heating elements and disposed to limit heat dissipation through the housing. The insulation can be a non-asbestos material with inert fillers and reinforcing agents. The deck can be a natural stone or synthetic material. One suitable natural stone is marble; a synthetic material can be MARINITE. Additionally, the oven can have an on-off switch on the back of the oven.

Additionally, the oven can have a fan directed at the controller. Optionally, the oven can have an alarm actuated by the controller when the heating period is over.

In another embodiment, there is a method of rapidly cooking and browning a food. First, the method provides an oven having i. a housing with four sides, a base and a top, one side being the front of the oven, a portion of the front being capable of opening as a door and another side being the back of the oven; ii. a first heating element capable of keeping the housing at greater than about 600° Fahrenheit, the first heating element being situated in the base of the housing; iii. a deck that sits on the base of the housing and above the first heating element, the deck being suitable for cooking a food; iv. a thermostat for monitoring the temperature of the inside of the housing; v. a second heating element situated in the top of the housing, suitable for browning a top surface of the food; vi. a button situated on the front side of the housing next to the door; and vii. a controller connected to the thermostat, the first heating element, the second heating element, the thermostat, and a button situated on the front side of the housing. The next step is to place the food on the deck inside the oven and then to actuate the button, to cause the controller to switch current from the first heating element to the second heating element that rapidly heats the top of the oven. The switch of power to the second heating element in the already hot oven hastens the overall heating and browning of the food.

### BRIEF DESCRIPTION OF DRAWINGS

FIG. 1 is a perspective view of the front of the oven

FIG. 2 is a perspective view of the back of the oven.

FIG. 3 is a schematic of the upper heating element.

### DETAILED DESCRIPTION

The inventive oven is designed to heat both the crust and cheese surfaces of a pizza (or other hot food) in a very short period of time. The inventive oven produces a hot pizza with crisp crust and melted, golden brown cheese surface in about a minute. The inventive oven has an appearance similar to a table-top microwave oven. However, it operates quite differently and produces a far superior pizza compared to microwaved pizza.

The oven has heating elements in its base and in its top. The bottom heating element heats a “stone,” on which a pizza pan is placed. The stone can be a natural stone capable of holding heat, such as marble. The stone also can be composed of synthetic materials such as TRANSITE 1000 (a non-asbestos material from BNZ Materials, Inc., Littleton, Colo.). The top heating element is capable of being rapidly heated and is separated from the food compartment by a metallic enclosure, making the oven interior easy to clean.

In operation, the oven is turned on before use for cooking; this allows the stone to come to a high temperature, sufficient to quickly heat the pizza from the bottom and to render the lower surface crispy. When an operator puts a pizza into the oven, he closes the door and actuates the upper heater. A cut-off switch stops electrical flow to the lower heater and directs electricity only to the upper heating element, which heats very rapidly and browns the upper surface of the pizza, preferably in about a minute. The cooking time is over when a cue such as a light or bell/buzzer is actuated.

The two heating elements can be any shape, but must provide coverage of the food to be heated. In one configuration, the heating elements are approximately the length and width of a section of a circular pizza pie, or triangular.

To maintain the high temperature inside the oven but not on the outer surface, the oven is well insulated. There are a variety of insulating materials that can be used. One example is MARINITE insulation, a non-asbestos, calcium silicate material with inert fillers and reinforcing agents, the exact formulation of which is chosen by the temperature to be maintained.

The electronics are positioned to one side and toward the back of the oven, insulated from the heat and cooled by a fan. The oven has a thermostat to aid in temperature maintenance by the lower heating element. Preferably, the thermostat is located in the base of the oven. In one configuration, the oven is provided with a dial, which can be rotated to optimize the oven temperature.

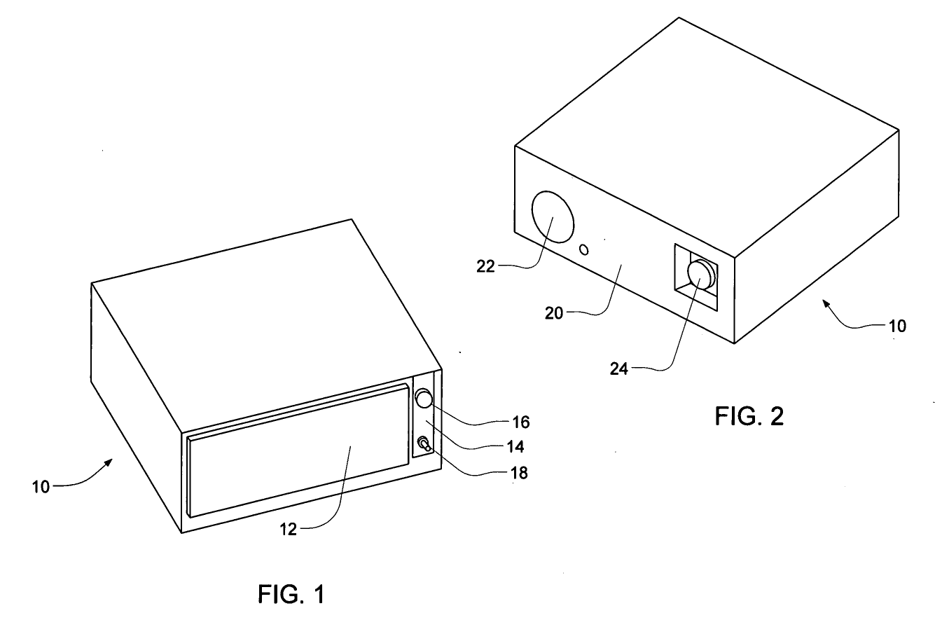

Turning now to the figures, FIG. 1 shows the front of the oven, including the oven 10 and the oven door 12. In one embodiment, the bottom of the door is equipped with a lip 13, which is grasped to open the door 12. Also on the front of the oven 10, is the control panel 14 to the side of the door 12. The control panel 14 features a depressible “on” button 16. When the button 16 is depressed, a light goes on behind the button and a timer is actuated for about one minute. A buzzer or other noise-maker (not shown) sounds when the time has expired, alerting the operator to remove the pizza. Depressing the button 16 directs electricity to the upper heating element, which heats very rapidly and browns the upper surface of the pizza, preferably in about a minute.

Every oven requires an on-off switch. The inventive oven 10 is shown in FIG. 1 with an on-off toggle switch 18. As shown in FIG. 1, the switch 18 is on the front control panel 14. However, a preferred location for the on-off toggle switch 18 is the back of the oven 10.

FIG. 2 shows the back 20 of the oven 10 with a screen 22 covering the fan (not shown) and a dial 24 to adjust the temperature. Behind the back panel of the over 10 are the microprocessor and wiring to operate the oven. In one embodiment, the dial 24 permits the user to turn off the oven, in addition to adjusting the temperature. This embodiment does not require a separate toggle switch 18.

While the outside of the oven 10 is a rectangular box, the inside is divided into compartments which are separated by insulation. The first compartment at the front of the oven 10 accepts food to be heated. In one embodiment, the first compartment is triangularly shaped to accept a pizza pie slice and to aid in the positioning of the slice between the upper and lower triangularly shaped heating elements. The first compartment is the heated compartment and is insulated from at least one other compartment.

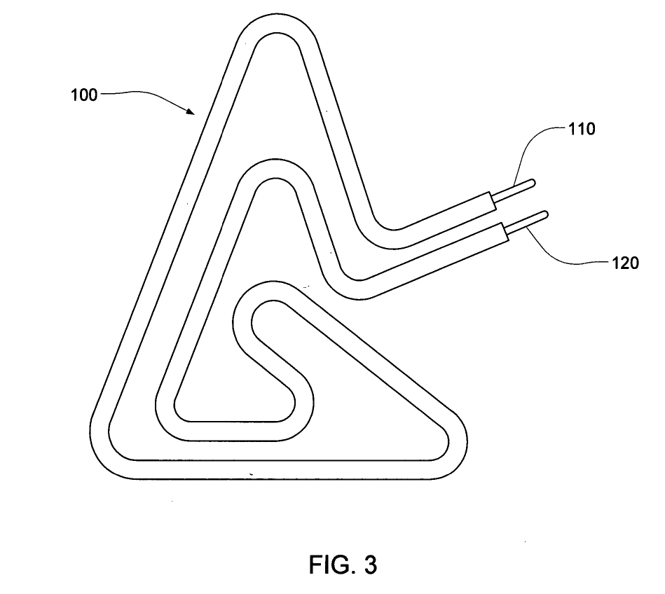

A second compartment is situated behind the control panel 14 and extends to the back 20 of the oven 10. The second compartment contains the electronics (not shown) which operate the oven 10. An electrical connection is supplied to the back of the oven and connects to a microprocessor, which in turn connects to a timer, button 16 and its internal light, alarm/ buzzer/bell. The microprocessor also connects to the heating elements. Once the electricity is turned on, the microprocessor sends current to a heating element in the base of the oven until the thermostat indicates that the selected temperature is reached. The temperature can be fine-tuned at the dial 24 on the back 20 of the oven 10. The operator leaves the temperature setting alone for the time period in which the oven is needed. Thus, the oven stays hot and is ready to quickly heat food. When the operator opens the oven and places a pizza slice inside, the operator closes the door and presses the button 16. Pressing the button 16 causes the microprocessor to send current to the second heating element that is in the upper part of the oven 10. This heating element 100 is shown in FIG. 3. In an oven embodiment for heating pizza slices, the heating element covers a triangular area, as shown in FIG. 3. The heating element 100 has cold ends 110 and 120 for making connections with the rest of the electrical circuit.

In operation, the operator turns on the oven at the beginning of the serving period (e.g., opening of the shop) and adjusts the temperature, if necessary. The oven starts heating to the desired temperature, which is thermostatically maintained until the oven is turned off at the end of the serving period. Later when a customer purchases a pizza slice, the operator opens door of the oven, places the slice inside on the “stone,” closes the door and presses the button. The button lights up, the upper heating element heats up and the pizza slice is cooked from the top and the bottom, until the light goes off and the bell rings. When the microprocessor turns off the light and rings the bell, it also stops current to the upper heating element. The operator opens the oven and removes the pizza slice for the user to enjoy.

While only one embodiment of the invention has been described, those skilled in the art will readily recognize adaptations and modifications that may be made to the present invention without departing from the spirit or the scope of the appended claims. Accordingly, the invention is to be limited only by the following claims.

1. A fast-cooking table top oven comprising
a. a housing with four sides, a base and a top, one side being the front of the oven, a portion of the front being capable of opening as a door, and another side being the back of the oven;
b. a first heating element capable of keeping the housing at over 700° Fahrenheit, the first heating element being situated in the base of the housing;
c. a deck that sits on the base of the housing and above the first heating element, the deck being suitable for cooking a food;
d. a thermostat for monitoring the temperature of the inside of the housing;
e. a second heating element situated in the top of the housing, suitable for browning a top surface of the food;
f. a button situated on the front side of the housing next to the door; and
g. a controller connected to the thermostat, the first heating element, the second heating element, the thermostat, and a button situated on the front side of the housing,
whereby the controller maintains the temperature within the housing using the thermostat by directing power to the first heating element, until the button is actuated, t which time it transfers power to the second heating element such that the second heating element rapidly heats up and thereby promptly cooks a food.

2. The oven of claim 1, further comprising insulation surrounding the heating elements and disposed to limit heat dissipation through the housing.

3. The insulation of claim 2, wherein the insulation is a non-asbestos material with inert fillers and reinforcing agents.

4. The oven of claim 1, wherein the deck is a natural stone or synthetic material.

5. The natural stone deck of claim 5, wherein the natural stone is marble.

6. The synthetic material of claim 4, wherein the material is MARINITE.

7. The oven of claim 1, further comprising an on-off switch on the back of the oven.

8. The oven of claim 1, further comprising a fan directed at the controller.

9. The oven of claim 1, further comprising an alarm actuated by the controller when the heating period is over.

10. A method of rapidly cooking and browning a food, the method comprising
a. providing the apparatus of claim 1 comprising
i. a housing with four sides, a base and a top, one side being the front of the oven, a portion of the front being capable of opening as a door and another side being the back of the oven; ii. a first heating element capable of keeping the housing at greater than about 600° Fahrenheit, the first heating element being situated in the base of the housing; iii. a deck that sits on the base of the housing and above the first heating element, the deck being suitable for cooking a food; iv. a thermostat for monitoring the temperature of the inside of the housing; v. a second heating element situated in the top of the housing, suitable for browning a top surface of the food; vi. a button situated on the front side of the housing next to the door; vii. a controller connected to the thermostat, the first heating element, the second heating element, the thermostat, and a button situated on the front side of the housing;
b. placing the food on the deck inside the oven;
c. actuating the button, to cause the controller to switch current from the first heating element to the second heating element that rapidly heats the top of the oven, whereby the switch of power to the second heating element in the already hot oven hastens the overall heating and browning of the food.
